(19) United States
(12) Patent Application Publication
(10) Pub. No.: US 2018/0341749 A1
(43) Pub. Date: Nov. 29, 2018

(54) SYSTEM AND METHOD FOR INTERACTIVELY DISPLAYING DIRECTIONS FOR USE FOR A PRODUCT

(71) Applicant: Adriana Monica Druma, San Jose, CA (US)

(72) Inventor: Adriana Monica Druma, San Jose, CA (US)

(73) Assignee: Adriana Monica Druma, San Jose, CA (US)

(21) Appl. No.: 15/607,514

(22) Filed: May 28, 2017

(51) Int. Cl. G06F 19/00

(52) U.S. Cl. CPC G06F 19/324

(57) ABSTRACT

The present invention describes a solution for delivering directions for use from pharmaceutical, medical device, automotive, consumer products, to the end user through a unique item-level tag located on the product, product user interface, or product label, through a custom computer program accessed through a mobile app using a mobile device such as a tablet or smart phone. In some embodiments of the invention the users are presented with information related to safety, indications, counter indications, warnings, recalls, or product holds. Embodiments of the invention may be used to provide context-specific information for a user through a tag displayed on the product user interface.

The present invention relates generally to surgical techniques and instructions/directions for use for medical devices and pharmaceutical products that require regulatory approval from the Food and Drug Administration (FDA) to be commercialized in the United States as well as consumer products that require directions for use.

### BACKGROUND OF THE INVENTION

Medical devices are classified by the FDA as class I, class II or class III medical devices. Most class II medical devices today are approved to be marketed (sold on the US market) as “substantially equivalent” devices through a regulatory process called “Pre-market notification” or 510(k). Most pharmaceuticals and class III medical devices are approved to be marketed (sold on the US market) through the Pre-market Approval (PMA) process. Clinical studies are most often conducted to support a PMA. An investigational device exemption (IDE) allows the investigation device to be used in clinical studies to collect safety and efficacy data for the device submitted for regulatory approval. Among the documents submitted by a device or pharma manufacturer to support the regulatory submission for the product are the instructions or directions for use for the proposed device. The regulatory agency reviews and provides feedback to the manufacturer for the proposed directions for use and approves the final copy that will be supplied to the user.

The directions for use contain several pieces of information that are of utmost importance to the user: indications for use, device description, contraindications and warnings, clinical trial results, data related to ratings and environmental effects, directions for device disposal (for single use devices), cleaning, re-sterilization (for reusable devices), complaint handling and customer service, contact information, etc. The global harmonization task force issued the “Label and instructions for use for medical devices” document in September 2011. This document is intended to provide guidance for use in the regulation of medical devices. The document outlines the content of instructions for use with the detailed list of information that needs to be included by the device manufacturer.

Currently the FDA and other regulatory bodies allow for electronic directions for use beside the traditional paper-based directions for use. The electronic directions for use are usually delivered though a website maintained by the manufacturer and are, by enlarge, an electronic (usually PDF) copy of the paper based directions for use. Both the paper and electronic directions for use are difficult to read due to the small font size and disorganized information that is delivered to the user. There is no good way to search through the intricate and stuffy material so that a user can extract the relevant information needed to use the device. At the same time, most operating rooms do not have readily available a decent size monitor connected to a computer to download the directions for use as they need to be accessed. In cases where the user is not familiar with the device or in “mission critical” situations where the user needs to use the device available within minutes or hours, deciphering the paper based or web based directions for use becomes a daunting task. The label and instructions for use for medical devices document states that instructions for use may be provided to the user either in paper or non-paper format such as displayed on a screen, incorporated into the device, downloaded from a website and readable using a machine such as a mobile tablet or smart phone.

Therefore, it would be advancement in the state of the art to provide interactive, context sensitive directions for use application for medical devices or pharmaceutical products that addresses the needs of the ever-expanding health care industry and regulatory bodies (such as FDA, TUV, etc). The various embodiments of the present invention were developed to address this need.

### SUMMARY OF THE INVENTION

Accordingly, one embodiment of the present invention is a method for tagging a medical device product with a 2D code located on the said medical device label, comprising the steps of printing on a product label a uniquely assigned identifier for that said product, retrieving the printed information from the product label through a mobile receiver (cell phone, barcode scanner, tablet, IPhone, Android phone, Windows phone, Blackberry, digital camera, laptop), having a one to one mapping with said product which when invoked, responds with a unique directions for use that are interactively delivered to the user. The identifier used to tag the product could be a barcode, text, image, RFID, NFC chip, or any other unique code assigned by the manufacturer to the said product or product line. A computer program is used to retrieve unique directions for use from a database to the said product. The directions for use for the said product are submitted by the device manufacturer to a third party in the form of a text file, image, sequence of images, direct input through a web portal and a uniquely assigned user name and password. The directions for use for the product may be delivered to the said user as context-sensitive directions for use.

Another embodiment of the present invention is the method for tagging a medical device with a 2D code located on the said medical device user interface, comprising the steps of retrieving context-sensitive information about the said product, displaying directions for use for the said product or procedure performed with the said product.

Another embodiment of the present invention is the method for tagging a medical device with a 2D code located on the graphical user interface of the said product, comprising the steps of retrieving context-sensitive information about the said product graphical user interface as it relates to a an error or fault displayed on the said graphical user interface, displaying help or troubleshooting information as it relates to the said product, using a computer program to connect to an expert system or human customer service representative to assist the user in troubleshooting the error or the fault in order to continue the procedure.

Another embodiment of the present invention is the method for displaying, searching, sorting, playing directions for use for a medical product either using text input from the user or voice input from the user. The text or voice input from the user may be specific to the geography where the user is located and may be delivered in the user's native language or English.

Another embodiment of the present invention is the method for displaying the most recent electronic version of directions for use of a product and informing the user of any recalls or holds for the said product with instructions on how to handle the hold or recall.

Another embodiment of the present invention is the method for displaying directions for use for a medical product further comprising the step of providing a date and time stamp of when the most recent directions for use were accessed via a mobile device.

Another embodiment of the present invention is the method for displaying the directions for use for a medical device where the user is a health care professional.

Another embodiment of the present invention is the method for displaying the directions for use for a pharmaceutical product where the user is a pharmacist or an end user.

Another embodiment of the present invention is the method for displaying directions for use for a medical product based on a geographic location of the user using translations of the original directions for use in English.

Another embodiment of the present invention is the method for displaying directions for use for medical product wherein said directions for use also display product safety information and expiration date.

### BRIEF DESCRIPTION OF THE DRAWINGS

FIG. 1 shows a flowchart of a method for tagging a medical product and retrieving Directions for use for the said medical product to deliver it to the user based on the rules in accordance with one embodiment of the invention.

FIG. 2 shows a block diagram of a system for retrieving the Directions for use for a medical product, converting the said Directions for use into interactive Directions for use, and delivering it to the user, in accordance with one embodiment of the invention.

FIG. 3 shows an illustration of an item-level barcode being used to instruct the user of medical product to use the product in accordance with the latest electronic Directions for use.

FIG. 4 shows an illustration of an item level barcode being used to troubleshoot a medical product using either a customer service representative or an expert system.

### DETAILED DESCRIPTION OF THE DRAWINGS AND INVENTION

This invention will be understood by the following detailed description used in conjunction with the accompanying drawings, where in like reference numerals designate like structural elements.

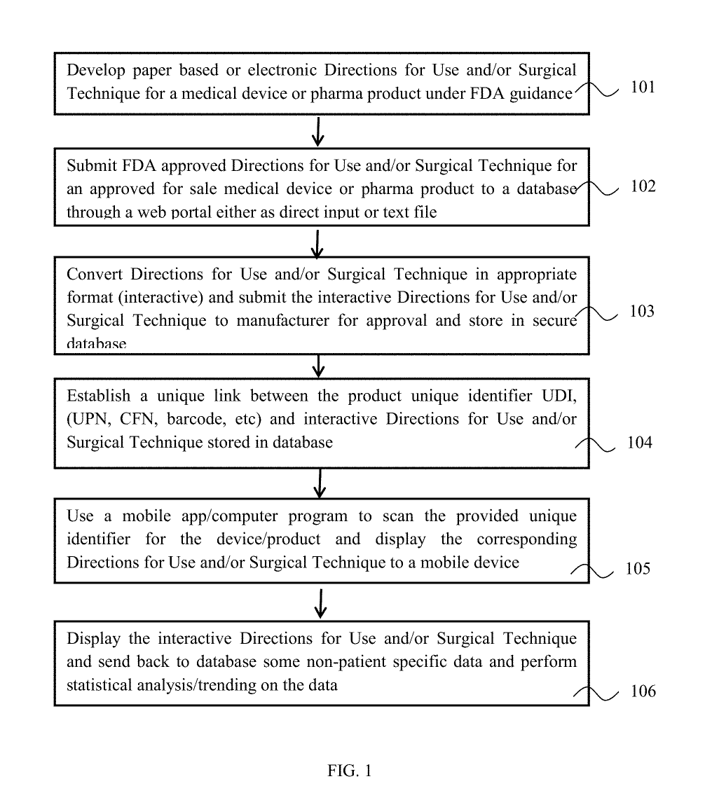

In FIG. 1 a flowchart 100 illustrates the sequential implementation of one embodiment of the invention. An initial step, 101, involves developing a draft, paper based or electronic directions for use, for a medical device or pharmaceutical product following regulatory body guidance. The required regulatory content includes anything the FDA or other regulatory agencies mandate what must be included in the directions for use and made available to the user such as device description, indications, counter indications, unique device identifier, expiration date, warnings or clinical test results.

The draft directions for use developed by the medical device manufacturer in step 101 are then submitted to the regulatory body as part of the submission package together with the required documentation for the product in step 102. The manufacturer of the product may involve a third-party firm to develop the directions for use for the device as an integrated part of the product development cycle. The approved directions for use at the end of step 102 is then converted into an appropriate interactive form by a third party or the product manufacturer and are submitted for device manufacturer approval and vetting in step 103. The approved interactive directions for use from step 103 are uniquely liked to the product line through a unique identifier such as universal product number, customer facing number, 2D bar code or radiofrequency identifier, or near field connection sensor in step 104. The interactive directions for use are stored in a secure data base at the end of step 104. A user can use a computer program through a customized mobile application to scan the provided unique identifier for the commercialized product and load, display, interrogate the directions for use that are uniquely linked to the commercialized product in step 105. The mobile application used to scan and display the directions for use for the commercialized product may send back an acknowledgment of accessed directions for use to the product manufacturer in step 106 and the data may be stored, processed, analyzed by either a third party or device manufacturer itself.

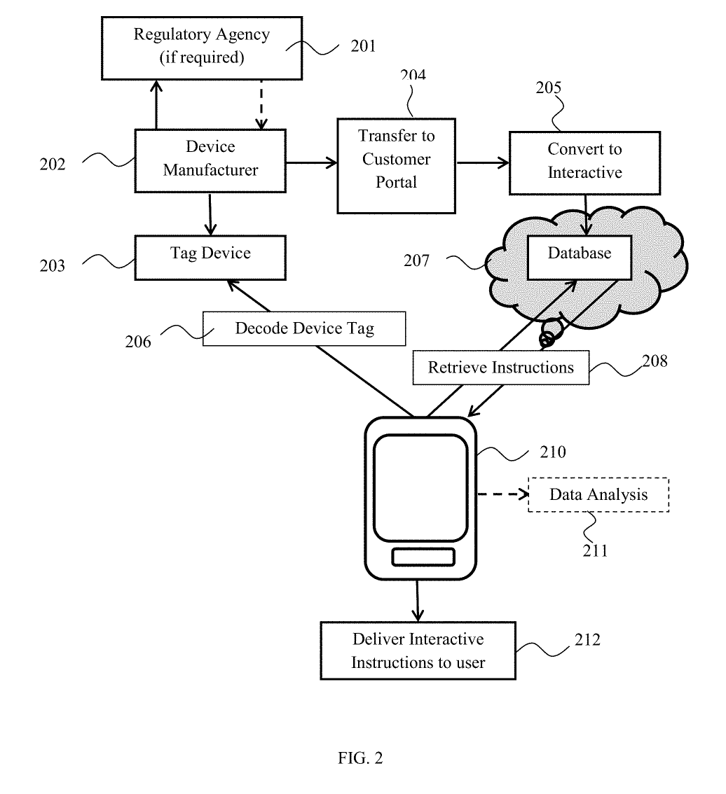

FIG. 2 shows a block diagram of a proposed system 200 for processing, storing, retrieving, and displaying the interactive directions for use from step 103. A device manufacturer 201 interacts with a regulatory agency 202 to finalize and agree on the directions for use for the product to be commercialized. The device manufacturer 202 transfers the approved directions for use to a portal 203. The approved directions for use are converted into interactive directions for use 204 using a computer program, human operator, or a combination thereof. The device manufacturer 201 uses a tag 205 to uniquely assign the interactive directions for use 204 to a line of like products that have the same directions for use. The product manufacturer or the third party stores the interactive directions for use 204 to a cloud based database 206. A mobile device 207 uses a reader 208 (that could be a mobile app or any other reading devices) and a custom computer code 209 to retrieve the interactive directions for use 204 and deliver (display, narrate, project, etc) the interactive directions for use 204 to a product user 210. A custom data analysis program 211 may be used for retrieving the information generated in the process of decoding, retrieving, displaying the interactive directions for use 204 such as the date and time of download, username, geolocation, etc. to perform custom data analysis that may be used for commercialization of marketing purposes.

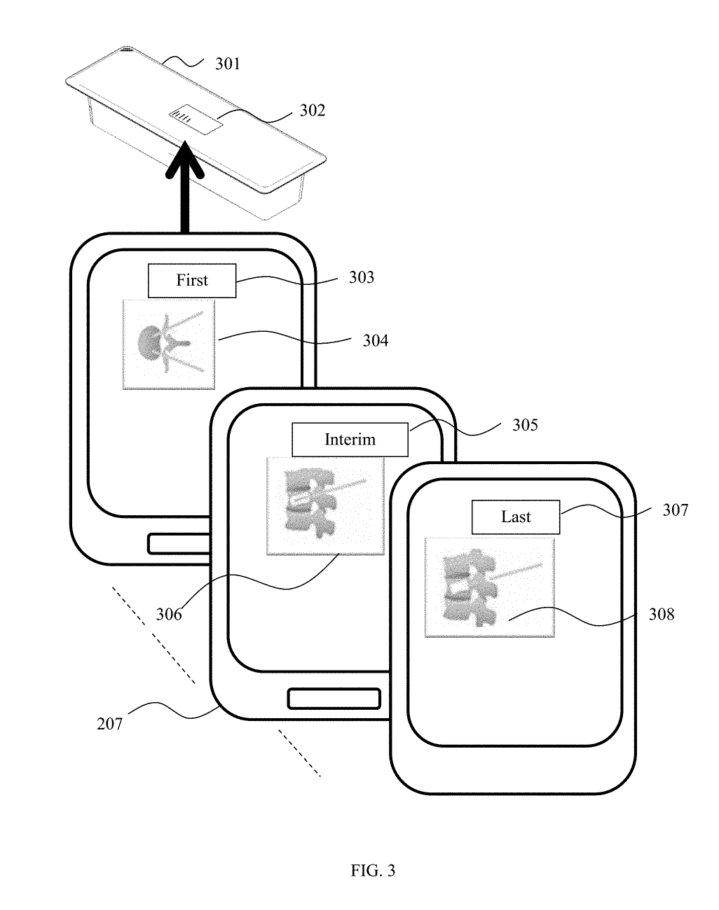

FIG. 3 shows an example of a product 301 that has a unique identifier 302 printed on the product label. The mobile device 207 shows a first step 303 displaying a first step of directions for use 304. Interim steps 305 display interim instances of the directions for use 306 using the mobile device 207. The mobile device 207 is then shown displaying a last step 307 of directions for use and a last instance of directions for use 308 that shows the end of the procedure. The first step 303, the interim steps 305 and the last step 307 may be translated in different languages and customized for the specific geographies where the product is used in accordance with the local requirements of the local regulatory bodies.

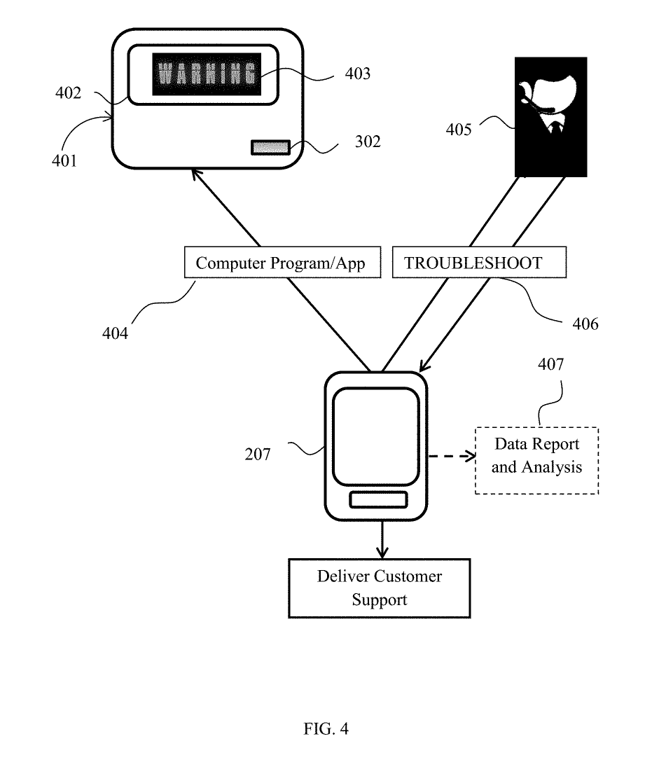

FIG. 4 shows an example of a medical device 401 that has the unique identifier 302 displayed on a user interface 402. A warning 403 is displayed on the medical device 401 through the user interface 402. The mobile device 207 is used to scan the unique identifier 302 using a custom computer program 404 through a mobile app and connects the user using the computer program 404 to a customer service representative 405. The customer service representative 405 may be a manufacturer employee, call center employee, clinical rep, sales rep, automated expert system. The user may interact with the customer service representative 405 to troubleshoot the warning 403 or provide directions for use for the specific step that user performs. The unique identifier 302 may be linked to context-specific information about the warning 403 and the mobile device 207 may exchange content-specific troubleshooting information 406 with the user in order to clear the warning 403. The computer program 404 may record and communicate the troubleshooting session to the device manufacturer as well as any other significant data such as error codes, fault codes, problems encountered during the step in question, any other issues the customer has with the medical device 401 in the form of log session 407. The log sessions 407 may be the used by the medical device manufacturer to improve, predict, and forecast use conditions for the medical device 401.

While the methods described herein have been described and shown with reference to particular operations that are performed in a particular sequence, it will be understood that these operations may be combined, divided, or reordered to create similar methods without departing from the present invention. Accordingly, unless specifically indicated herein, the order and grouping of the operations is not a limitation of the present invention.

While the present invention has been particularly shown and described with reference to embodiments thereof, it will be understood by those skilled in the arts that various other embodiments may be in scope of the present invention as defined by the claims.

What is claimed is:

1. A method of converting printed directions for use from a medical device, pharma, or consumer goods manufacturer into interactive directions for use comprising the steps of:
submitting a printed or electronic, regulatory approved directions for use through a web portal to a third-party supplier;
tagging a product line with a unique identifier having a one-to-one mapping to the approved directions for use;
converting the printed or electronic regulatory approved directions for use into interactive directions for use;
providing a unique link between the interactive directions for use and the unique identifier of the tagged product line;
using a mobile app to retrieve the interactive directions for use of a product of the said product line associated with the directions for use;
using the mobile app to deliver the said directions for use to a user of the said product;
using the mobile app to collect information about the usability of the said product and return it for third party analysis.

2. The method of claim 1 wherein the directions for use are instructions for use.

3. The method of claim 1 wherein the user is a nurse or health care professional.

4. The method of claim 1 wherein the user is a surgeon.

5. The method of claim 1 wherein the user is a pharmacist.

6. The method of claim 1 wherein the user is an end-user consumer.

7. The method of claim 1 further comprising providing the user with customer service support.

8. The method of claim 7 wherein the customer support is delivered in the form of an interaction between the user and an expert system that guides the user through a troubleshooting session to help the user set-up or use the said product in the said product line.

9. The method of claim 1 further comprising providing the user with most recent information about the product line and individual product from the said product line.

10. The method of claim 9 further comprising providing the user with dosage, safety and methods to take medication and medication schedule information using the said mobile app.

11. A system of converting printed directions for use from a medical device, pharma, or consumer goods manufacturer into interactive directions for use comprising:
a printed or electronic, regulatory approved directions for use submitted by a manufacturer through a portal to a third-party supplier;
a tag on a product line with a unique identifier having a one-to-one mapping to the approved directions for use;
converted regulatory approved directions for use into interactive directions for use;
a unique link between the interactive directions for use and the unique identifier of the tagged product line;
a mobile app used to retrieve the interactive directions for use of a product of the said product line associated with the directions for use;
using the mobile app to deliver the said directions for use to a user of the said product;
using the mobile app to collect information about the usability of the said product and return it for third party analysis.

12. The system of claim 11 wherein the directions for use are instructions for use.

13. The system of claim 11 wherein the user is a nurse or health care professional.

14. The system of claim 11 wherein the user is a surgeon.

15. The system of claim 11 wherein the user is a pharmacist.

16. The system of claim 11 wherein the user is an end-user consumer.

17. The system of claim 11 further comprising providing the user with customer service support.

18. The system of claim 17 wherein the customer support is delivered in the form of an interaction between the user and an expert system that guides the user through a troubleshooting session to help the user set-up or use the said product in the said product line.

19. The system of claim 11 further comprising providing the user with most recent information about the product line and individual product from the said product line.

20. The system of claim 19 further comprising providing the user with dosage, safety and methods to take medication and medication schedule information using the said mobile app.
